(19) United States
(12) Patent Application Publication
(10) Pub. No.: US 2025/0211420 A1
(43) Pub. Date: Jun. 26, 2025

(54) TECHNIQUES FOR COMPRESSED ROUTE TABLES FOR CONTENTION-FREE ROUTING ASSOCIATED WITH NUMBER-THEORETIC- TRANSFORM AND INVERSE-NUMBER-THEORETIC-TRANSFORM COMPUTATIONS

(71) Applicant: Intel Corporation, Santa Clara, CA (US)

(72) Inventors: Raghavan KUMAR, Hillsboro, OR (US); Sanu K. MATHEW, Portland, OR (US)

(21) Appl. No.: 18/391,281

(22) Filed: Dec. 20, 2023

(51) Int. Cl. H04L 9/06; H04L 9/00

(52) U.S. Cl. CPC H04L 9/0631; H04L 9/008

(57) ABSTRACT

Examples include techniques for contention-free routing for number-theoretic-transform (NTT) or inverse-NTT (iNTT) computations routed through a parallel processing device. Examples include a tile array that includes a plurality of tiles arranged in a 2-dimensional mesh interconnect-based architecture. Each tile includes a plurality of compute elements configured to execute NTT or iNTT computations associated with a fully homomorphic encryption workload. Contention-free routing to include use of grouped or compressed source addresses to be used in routing tables maintained at tiles of the tile array.

### STATEMENT REGARDING FEDERALLY SPONSORED RESEARCH

This invention was made with Government support under contract number HR0011-21-3-0003 -0104 awarded by the Department of Defense. The Government has certain rights in this invention.

### TECHNICAL FIELD

Examples described herein are generally related to techniques associated with compressed routing tables used for contention-free routing for number-theoretic transform (NTT) and inverse-NTT (iNTT) computations through a parallel processing device for accelerating fully homomorphic encryption (FHE) workloads.

### BACKGROUND

Number-theoretic-transforms (NTT) and inverse-NTT (iNTT) can be important operations for accelerating fully homomorphic encryption (FHE) workloads. NTT/iNTT computations/operations can be used to reduce runtime complexity of polynomial multiplications associated with FHE workloads from O(n²) to O(nlogn), where n is the degree of the underlying polynomials. NTT and iNTT operations can be mapped for execution by computational elements included in a parallel processing device. The parallel processing device could be referred to as a type of accelerator device to accelerate execution of FHE workloads.

### BRIEF DESCRIPTION OF THE DRAWINGS

FIG. 1 illustrates an example system.

FIG. 2 illustrates an example connection scheme.

FIG. 3 illustrates an example NTT routing schedule.

FIG. 4 illustrates an example tile sub-system.

FIG. 5 illustrates an example tile.

FIG. 6 illustrates an example direction table.

FIG. 7 illustrates an example router sub-system for a tile.

FIG. 8 illustrates a first example of a router sub-system portion.

FIG. 9 illustrates example routing table schemes.

FIG. 10 illustrates a second example of a router sub-system portion.

FIG. 11 illustrates an example process flow.

FIG. 12 illustrates example top channel unsorted NTT compressed source addresses.

FIG. 13 illustrates example top channel sorted NTT compressed source addresses.

FIG. 14 illustrates example bottom channel unsorted NTT compressed source addresses.

FIG. 15 illustrates example bottom channel sorted NTT compressed source addresses.

FIG. 16 illustrates an example logic flow.

FIG. 17 illustrates an example computing system.

FIG. 18 illustrates a block diagram of an example processor and/or System on a Chip (SoC) that may have one or more cores and an integrated memory controller.

### DETAILED DESCRIPTION

In some examples, NTT and iNTT operations can be mapped for execution by computational elements included in a parallel processing device. The parallel processing device may include reconfigurable compute elements such reconfigurable butterfly circuits. These reconfigurable butterfly circuits can be arranged in separate groups organized in a plurality of tiles. These butterfly circuits can perform single instruction, multiple data (SIMD) add, multiply, multiply-and-accumulate, subtraction, etc. Unlike other SIMD operations, NTT operations also require shuffling of polynomial coefficients after computation on groups of butterfly circuits included in a respective tile. For example, for large polynomial ring sizes, this involves a significant amount of data movement between tiles. For example, a parallel processing device can include around 8,192 configurable butterfly circuits organized across 64 tiles. This equates to 128 butterfly circuits per tile and if each butterfly circuit has a 64 bit output, around 8,192 bits or 1 kilobyte (KB) of data can be moved across or between a pair of tiles. So for a 64 tile array, the resulting data movement would be about 64 KB. Moving this relatively large amount of data across all tiles of the parallel processing device needs a routing fabric to facilitate efficient data movement to achieve high throughput for NTT or iNTT operations. Efficient data movement can improve an overall performance of FHE workloads executed by the parallel processing device or accelerator implementing NTT/iNTT operations.

A first solution for data movement across tiles of a parallel processing device that includes processing elements such as butterfly circuits can involve use of dedicated point-to-point connections between tiles. For example, a dedicated point-to-point interconnect that involves Manhattan routing paths between tiles for a 64-tile array with 8,192 butterfly circuits organized in an 8×8 grid would need links capable of moving 1 KB of data between tiles, as mentioned above for NTT or iNTT operations. These 1 KB wide point-to-point connections move data from a source tile to a destination tile in the 64 tile array. This type of dedicated point-to-point connection scheme for NTT or iNTT operations can require a significant amount of routing channels and resources to ensure contention-free routing for data movement between a source tile and a destination tile. Silicon area during a physical design flow could grow as much as 2-3 times to accommodate this type of dedicated point-to-point connection scheme to implement NTT/iNTT operations/computations.

A second solution that attempts to mitigate silicon area growth for tile to tile data movement is to serialize or break up data movement via point-to-point connections into small chunks. The smaller chunks can reduce the width of data paths but a penalty will occur as NTT/iNTT operations/computations throughput will be reduced. Reduced throughput for NTT/iNTT operations/computations reduces overall performance for execution of FHE workloads.

A third solution that is described in greater detail below, involves use of a scalable and reconfigurable parallel processing device that has compute elements arranged to execute NTT and iNNT operations/computations and can be configured to route data in packets between tiles based on programmable contention-free routing schedules for NTT/iNTT operations/computations that can be initiated at a beginning of an FHE workload execution. The programmable contention-free routing schedules cause generation or creation of routing tables for use to route data between tiles arranged in a 2-dimensional (2D) mesh array. This third solution can require ‘N’ entries for each routing table, where N represents the total number of tiles in the 2D mesh array or grid. Also, a corresponding routing table entry can be indexed by a packet's source or destination address. The indexed table entry can be fetched by routing circuitry at a tile using a look-up table operation to determine an appropriate destination port of tile to route the packet. A look-up table operation can be mapped to a N-to-1 multiplexer and can be performed in a single clock cycle, such that the packet (e.g., including a KB of data) can be routed to a destination port without additional pipeline stages. For this third solution, a look-up table operation becomes a critical path and can limit a peak performance of the scalable and reconfigurable parallel processing device.

The third solution addresses problems mentioned above for the first two solutions in a manner that can boost throughput compared to serialized point-to-point connections and enables a user to program contention-free routing schedules that can provide latency versus throughput trade-off options to minimize silicon area growth. However, a relatively large routing table that includes 64 entries for a 64 tile 2D mesh array can require a 64-1 multiplexer for look-up table operations. The relatively large routing table and 64-1 multiplexer can limit the peak performance of the scalable and reconfigurable parallel processing device. As presented in this disclosure, examples are described that compress the routing tables at each tile to have >8× less entries and hence require significantly smaller multiplexers for look-up table operations to determine destination ports to route packets.

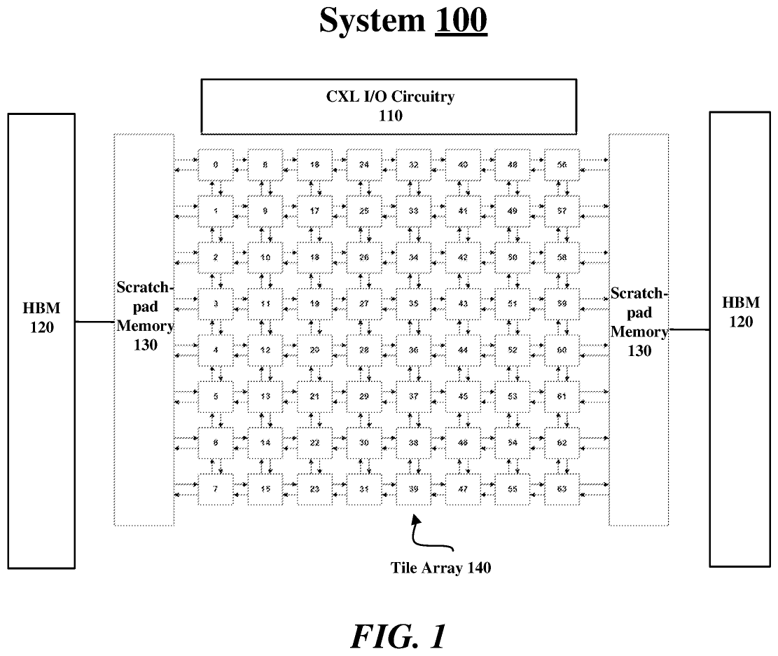

FIG. 1 illustrates an example system 100. In some examples, system 100 can be included in and/or operate within a compute platform. The compute platform, for example, could be located in a data center included in, for example, cloud computing infrastructure, examples are not limited to system 100 included in a compute platform located in a data center. As shown in FIG. 1, system 100 includes compute express link (CXL) input/output (I/O) circuitry 110, high bandwidth memory (HBM) 120, scratchpad memory 130 or tile array 140.

In some examples, system 100 can be configured as a parallel processing device or accelerator to perform NTT/iNTT operations/computations for accelerating FHE workloads. For these examples, CXL I/O circuitry 110 can be configured to couple with one or more host central processing units (CPUs-not shown) to receive instructions and/or data via circuitry designed to operate in compliance with one or more CXL specifications published by the CXL Consortium to included, but not limited to, CXL Specification, Rev. 2.0, Ver. 1.0, published Oct. 26, 2020, or CXL Specification, Rev. 3.0, Ver. 1.0, published Aug. 1, 2022. Also, CXL I/O circuitry 110 can be configured to enable one or more host CPUs to obtain data associated with execution of accelerated FHE workloads by compute elements included in interconnected tiles of tile array 140. For example, data (e.g., ciphertext or processed ciphertext) may be received to or pulled from HBM 120 and CXL I/O circuitry 110 can facilitate the data movement into or out of HBM 120 as part of execution of accelerated FHE workloads. Also, scratchpad memory 130 can be a type of memory (e.g., register files) that can be proportionately allocated to tiles included in tile array 140 to facilitate execution of the accelerated FHE workloads and to perform NTT/iNTT operations.

In some examples, as described in more detail below, tile array 140 can be arranged in an 8×8 tile configuration as shown in FIG. 1 that includes tiles 0 to 63. For these examples, each tile can include, but is not limited to, 128 compute elements (not shown in FIG. 1). Also, as described in more detail later, the 128 compute elements can be 128 separately reconfigurable butterfly circuits, which are configured to compute output terms associated with polynomial coefficients for NTT/iNTT operations/computations. As shown in FIG. 1, tiles 0 to 63 can be interconnected via point-to-point connections via a 2D mesh interconnect-based architecture.

The 2D mesh enables communications between adjacent tiles using single-hop links. Tiles included in tile array 140 can be augmented with router circuitry that can route data received via inputs or sent via outputs across all 4 directions.

Examples are not limited to use of CXL I/O circuitry such as CXL I/O circuitry 110 to facilitate receiving instructions and/or data or providing executed results associated with FHE workloads. Other types of I/O circuitry and/or additional circuitry to receive instructions and/or data or provide executed results are contemplated.

Examples are not limited to HBM such as HBM 120 for receiving data to be processed or to store information associated with instructions to execute an FHE workload or execution results of the FHE workload. Other types of volatile memory or non-volatile memory are contemplated for use in system 100. Other type of volatile memory can include, but are not limited to, Dynamic RAM (DRAM), DDR synchronous dynamic RAM (DDR SDRAM), GDDR, static random-access memory (SRAM), thyristor RAM (T-RAM) or zero-capacitor RAM (Z-RAM). Non-volatile types of memory can include byte or block addressable types of non-volatile memory such as, but not limited to, multi-threshold level NAND flash memory, NOR flash memory, single or multi-level phase change memory (PCM), resistive memory, nanowire memory, ferroelectric transistor random access memory (FeTRAM), anti-ferroelectric memory, resistive memory including a metal oxide base, an oxygen vacancy base and a conductive bridge random access memory (CB-RAM), a spintronic magnetic junction memory, a magnetic tunneling junction (MTJ) memory, a domain wall (DW) and spin orbit transfer (SOT) memory, a thyristor based memory, a magnetoresistive random access memory (MRAM) that incorporates memristor technology, spin transfer torque MRAM (STT-MRAM), or a combination of any of the above.

According to some examples, system 100 can be included in a system-on-a-chip (SoC). An SoC is a term often used to describe a device or system having a compute elements and associated circuitry (e.g., I/O circuitry, butterfly circuits, power delivery circuitry, memory controller circuitry, memory circuitry, etc.) integrated monolithically into a single integrated circuit (“IC”) die, or chip. For example, a device, computing platform or computing system could have one or more compute elements (e.g., butterfly circuits) and associated circuitry (e.g., I/O circuitry, power delivery circuitry, memory controller circuitry, memory circuitry, etc.) arranged in a disaggregated collection of discrete dies, tiles and/or chiplets (e.g., one or more discrete compute die arranged adjacent to one or more other die such as memory die, I/O die, etc.). In such disaggregated devices and systems the various dies, tiles and/or chiplets could be physically and electrically coupled together by a package structure including, for example, various packaging substrates, interposers, interconnect bridges and the like. Also, these disaggregated devices can be referred to as a system-on-a-package (SoP).

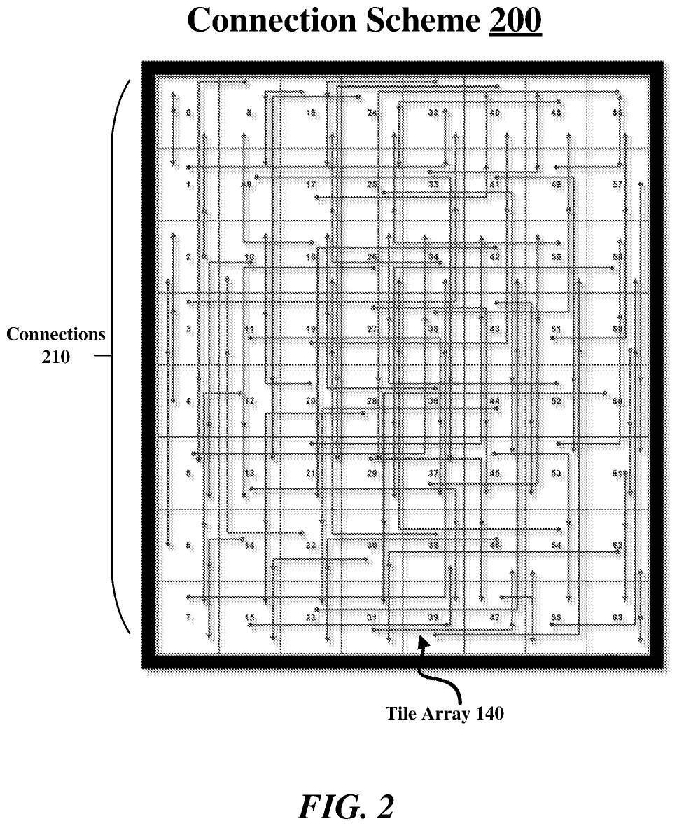

FIG. 2 illustrates an example connection scheme 200. According to some examples, connection scheme 200 shows how an 8×8 grid of tiles 0-63 of tile array 140 can be interconnected via connections 210 to perform an NTT operation on polynomials with 16,394 coefficients. For these examples, each tile can include 128 compute elements or butterfly circuits. Each point-to-point link included in connections 210 between tiles can be configured to carry 64 bits output from each of 128 butterfly circuits included in a single tile. So, each point-to-point link included in connections 210 can be configured to carry around 8,192 bits or 1 KB of data (e.g., in a packet form).

Connection scheme 200 is an example of how paths can be routed between tiles to implement an NTT operation using a Manhattan source-destination routing scheme. For implementing an iNTT operation, paths between tiles included in tile array 140 will have source and destination tile ordering reversed. In other words, the direction of the arrows shown in FIG. 2 are reversed. For example, for implementing an NTT operation, data from a source tile of 1 is routed to a destination tile of 32 through tiles 9, 17, 25 and 33. For implementing an iNTT operation, tile 32 is the source and tile 1 is the destination and the routing of data is through 33, 25, 17 and 9 to reach destination tile 1.

According to some examples, a scalable and reconfigurable method to implement connections between tiles executing NTT or iNTT operations/computations associated with an FHE workload can occur over a 2D mesh interconnect such as shown in FIG. 1 for system 100. The scalable and reconfigurable method can enable a contention-free routing by construction. As described in more detail below, tiles 0-63 of tile array 140 can each include router circuitry that is arranged to direct incoming packets to appropriate output ports using routing tables that can be compressed to include a significantly reduced amount of entries. As data routing paths for NTT/iNTT operations/computations are known or predetermined, a user can program contention-free routing schedules and program routing tables with compressed entries at a beginning of an FHE workload. Butterfly circuitry included in each tile of tile array 140 can be arranged to execute in a SIMD nature for the FHE workload. The SIMD nature for the FHE workload enables a reuse of router circuitry between NTT and iNTT operations/computations by replicating only the routing table, while sharing decoder circuitry.

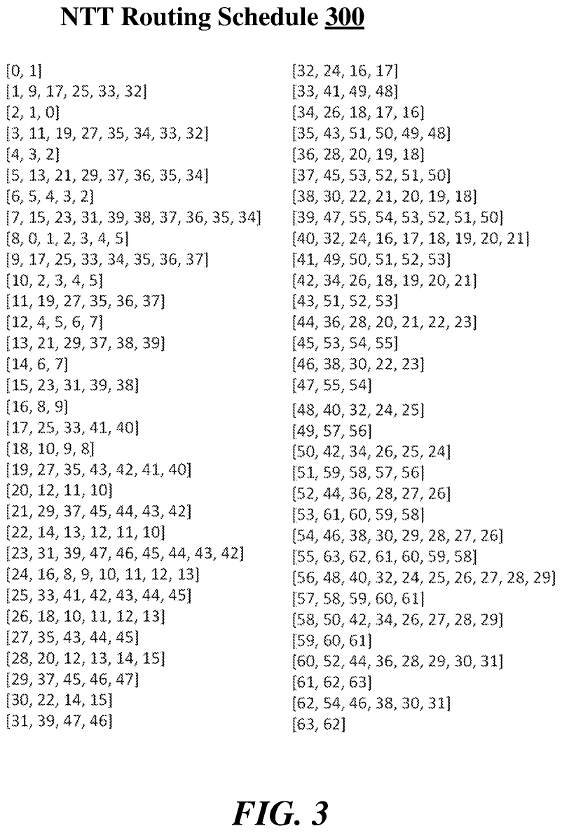

FIG. 3 illustrates an example NTT routing schedule 300. As mentioned previously, data movement for NTT and iNTT operations/computations can be achieved over a 2D mesh interconnect-based architecture as shown in FIG. 1 using a Manhattan source-destination routing scheme as shown in FIG. 2. NTT routing schedule 300 can be encoded into routing tables that provide contention-free routing paths for router circuitry to use for routing packets through a tile array. Contention can be defined as a scenario, where two incoming packets received at router circuitry at a tile have a same output port for routing. Routing paths encoded in routing tables based on NTT routing schedule 300 can be constructed such that they are contention-free by construction. Contention-free routes for all 64 tiles included in tile array 140 are shown in FIG. 3 for a 16K polynomial ring size example NTT operations/computations.

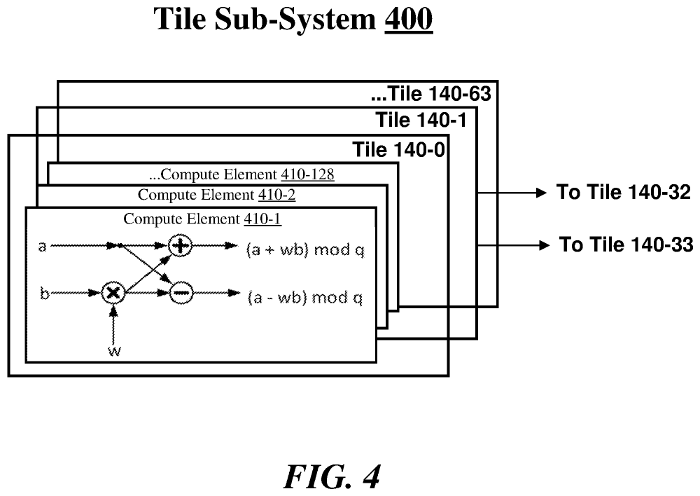

FIG. 4 illustrates an example tile sub-system 400. According to some examples, as shown in FIG. 4, tile sub-system 400 includes tiles 140-0 to 140-63 of tile array 140. Also, compute elements 410-1 to 410-128 illustrate the 128 compute elements included in tile 140-0. For these examples, compute elements 410-1 to 410-128 can include decimation-in-time (DIT) butterfly circuits that includes a modular multiplier coupled to an adder and subtractor.

Although not shown in FIG. 4, other types of butterfly circuits such as decimation-in-frequency (DIF) butterfly circuits are contemplated, so examples are not limited to DIT butterfly circuits. NTT operations/computations for FHE workloads can be performed by the 128 compute elements configured as butterfly circuits and included in each tile of tile array 140. The NTT operations can include each butterfly circuit computing output terms a+b*w, a-b*w, where a and b are polynomial coefficients, while w is a twiddle factor, which depends on an underlying modulus term.

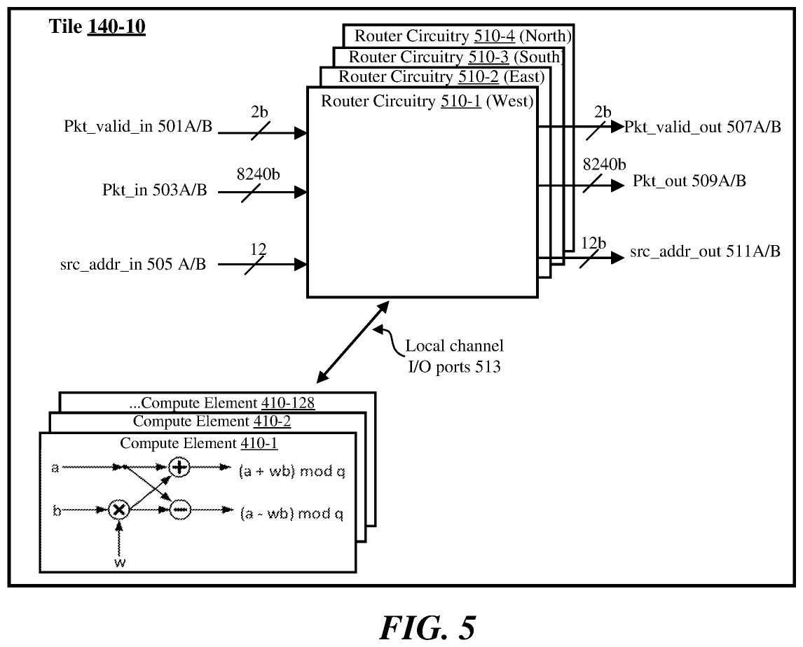

Unlike add, subtraction and multiplication operations, NTT operations/computations also involve a fixed permutation of butterfly circuit outputs, where a permutation pattern depends on the degree of an underlying polynomial. Connection scheme 200 shown in FIG. 2 depicts a permutation network for a 16K polynomial ring size mapped to tile array 140 in an 8×8 grid. According to some examples, the two outputs lanes or channels (e.g., top and bottom channels) from butterfly circuits included in the 128 compute elements of a tile are sent to two destination tiles, where each destination tile is to receive one of the output lanes or channels. For example, as shown in FIG. 4, output channels from tile 140-1 are sent to tiles 140-32 and 140-33. FIG. 5 illustrates an example tile 140-10 from tile array 140. In some examples, as shown in FIG. 5, tile 140-10 includes router circuitry 510-1 to 510-4. For these examples, router circuitry 510 is replicated 4 times to service up to 4 directions (west, east, south, north) simultaneously/concurrently and to also service routing of data to local compute elements 410-1 to 410-128 if data is destined for tile 140-10. Example routing activities that occur within/by components of router circuitry 510 are described in more detail below.

According to some examples, in order to accommodate two output lanes or channels from compute elements 410-1 to 410-128, router circuitry 510 can implement two identical routing channels A and B. Routing channels A/B are not shown in FIG. 5 but are implied via Pkt_valid_in 501A/B, Pkt_in 503A/B, src-addr_in 505A/B, Pkt_valid-out 507A/B, Pkt_out 509A/B and src_addr_out 511A/B signals. For example, Pkt_valid_in 501A/B signal is shown in FIG. 5 as including a 2 bit signal−1 bit for the A channel and 1 bit for the B channel. Similarly, the number of bits shown for the other signals are equally split between the A and B channels.

In some examples, Pkt_valid_in 501A/B signals can carry 2 bits of data to indicate a valid packet has been sent to tile 140-10, Pkt_in 503A/B signals can carry 8240 bits of data included in packets to be processed by compute elements 410, src_addr_in 505A/B signals can carry 12 bits of data to indicate a source address for data included in packet to be processed for an NTT/iNTT operation/computation. Also, Pkt_valid_out 507A/B signals can carry 2 bits of data to indicate that tile 140-10 is sending a valid packet to a next tile, Pkt_out 509A/B signals can carry 8240 bits of data included in packets to be sent to a destination tile, and src_addr_out 511A/B signals can carry 12 bits to indicate the source address for the data included in a packet to be processed for the NTT/iNTT operation/computation. Examples are not limited to the bits shown in FIG. 5 for A/B signals that are based on a 16K polynomial mapped to tile array 140.

The size of the polynomial ring mapped to a tile array will increase or decrease bits carried by at least Pkt_in 503A/B, src_addr_in 505A/B, Pkt_out 509A/B, or src_addr_out 511A/B signals to implement NTT/iNTT operations.

Although only tile 140-10 is shown in FIG. 5, all tiles included in tile array 140 can have the same replicated router circuitry.

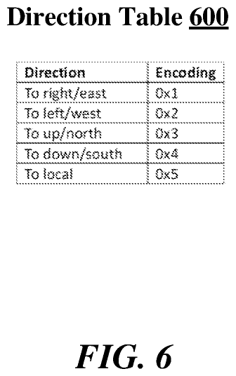

FIG. 6 illustrates an example direction table 600. According to some examples, as shown in FIG. 6, direction table 600 provides example encodings to indicate which output port to use as a routing path to send in-transit or locally generated packets in 4 possible directions (0×1−0×4), as well as a local delivery (0×5) if the current tile is the destination for a received packet. In an example of an 8×8 tile array, an uncompressed routing table can have 64 source address entries or, as described more below, compressed routing tables can have 7 or fewer source address entries. Respective source address entries in either uncompressed or compressed routing tables can contain values that encode the 4 possible directions, as well as a local delivery as shown in direction table 600. A source address of a received packet (e.g., received via src_add_in 505), can be used in a look-up table operation to fetch an encoded value for that source address from the routing table to determine a destination port to route the packet. The encoded value to be based on a contention-free route through the 8×8 tile array from the source tile to a destination tile for an NTT/iNTT operation/computation.

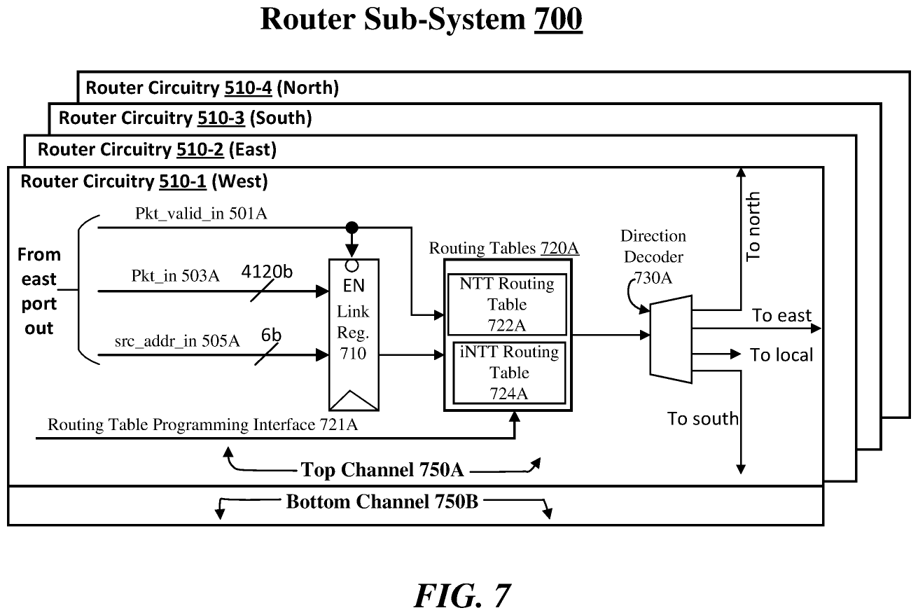

FIG. 7 illustrates an example router sub-system 700. In some examples, router sub-system 700 shows components of router circuitry 510-1 (e.g., router circuitry 510-1 for tile 140-10) For these examples, as shown in FIG. 7 a top channel 750A of router circuitry 510-1 includes a link register 710A, a routing table programming interface 721A, routing tables 720A, and a direction decoder 730A. Routing tables 720A include an NTT routing table 722A that are based on contention-free routes through tile array 140 for NTT operations/computations. Routing tables 720A can be reconfigured for router circuitry 510-1 via routing table programming interface 721A. Routing tables 720A also include an iNTT routing table 724A that are based on contention-free routes through tile array 140 for iNTT operations/computations. Both routing tables included in routing tables 720A can be reconfigured for router circuitry 510-1 via routing table programming interface 721A. For example, programmable registers or allocated memory of a tile can be used to maintain routing tables 720A and these programmable registers or allocated memory can be programmed/accessed via routing table programming interface 721A to configure or reconfigure routing tables 720A (e.g., at initiation of an FHE workload).

Although not shown in FIG. 7 bottom channel 750B includes duplicated components of a link register 710B, a routing table programming interface 721B, routing tables 720B, and a direction decoder 730B. According to some examples, identical components included in top channel 750A and bottom channel 750B can be designed to accommodate two output lanes or channels for data generated by compute elements 410-1 to 410-128 included in a tile or for in-transit packets that include data generated by compute elements at other tiles.

As mentioned above and shown in both FIGS. 5 and 7, router circuitry 510-1 is replicated in router circuitry 510-2, 510-3 and 510-4 to service up to 4 directions simultaneously. In some examples, an incoming packet received via Pkt_in 503A associated with a corresponding valid signal received via Pkt_valid_in 501A and a source address of the packet indicated in src_addr_in 505A. For these examples, the source address of the packet is captured in link register 710A. The source address can then be used in a look-up table operation to fetch an encoded value in an entry of a routing table included in routing tables 720A, the entry to correspond to the source address. Direction decoder 730A can cause the packet to be routed to a destination port based on the encoded value that is encoded, for example, according to example direction table 600.

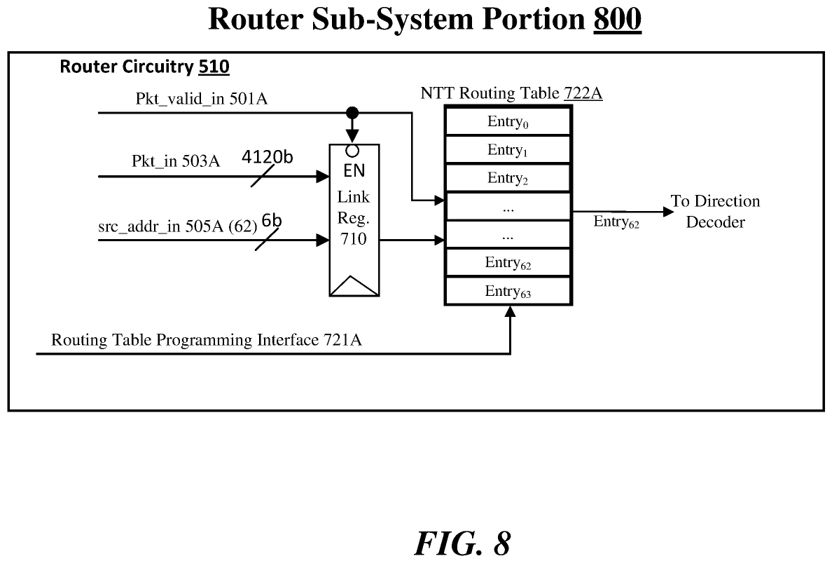

FIG. 8 illustrates an example router sub-system portion 800. According to some examples, router sub-system portion 800 can represent any top channel router circuitry of router circuitry 510-1-4 of router sub-system 700 shown in FIG. 7 and described above. For these examples, as shown in FIG. 8, NTT routing table 722A includes a uncompressed 64 entry routing table having entries 0-63. Respective entries 0-63 can be assigned to a source address and based on a source address indicated in src_addr-in 505A as (62) a table look-up operation can be performed to fetch an encoded value from the entry of NTT routing table 722A assigned to a source address for tile 62 and provide that encoded value to a direction decoder to determine what destination port to send a packet received via Pkt-in 503A signal that has a corresponding Pkt-valid_in 501A signal.

Although not shown in FIG. 8, a table look-up operation for a 64 entry NTT routing table 722A can require circuitry to support a 64-1 multiplexer. Looking through the 64 entries with a 64-1 multiplexer can limit peak performance of a scalable and reconfigurable parallel processing device such as supported by array 140 of system 100 for NTT/iNTT operations/computations. As described more below, a smaller, compressed routing table can be configured that reduces by greater than 8× a number of entries in the smaller, compressed routing table. Therefore, a smaller multiplexer (e.g., 7-1 or 6-1) can be used for table look-up operations and can have a reduced impact on peak performance of the scalable and reconfigurable parallel processing device.

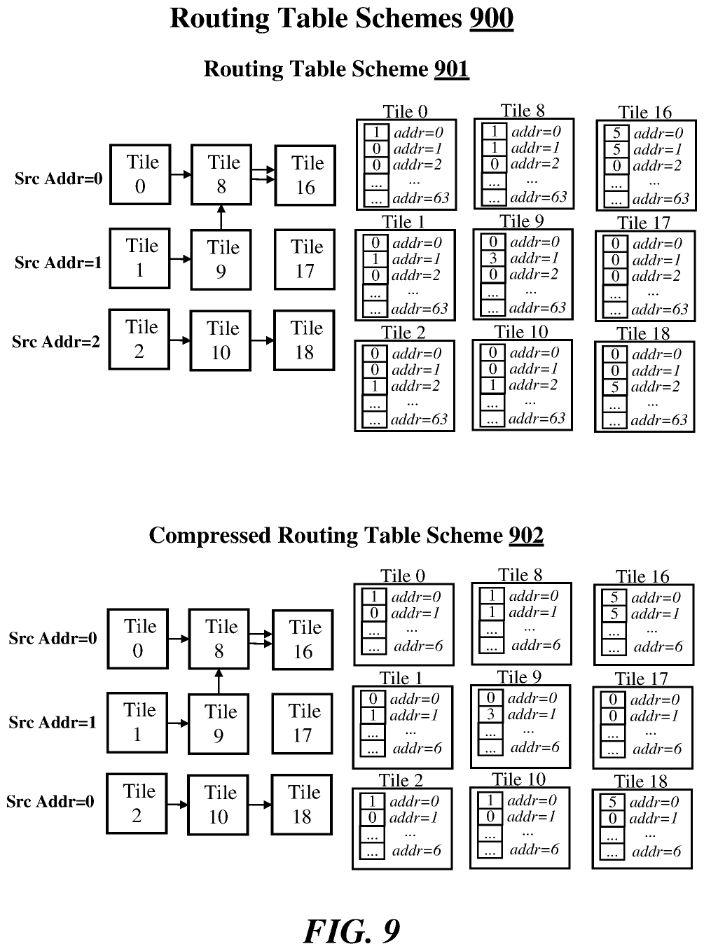

FIG. 9 illustrates example routing table schemes 900. According to some examples, routing table scheme 901 and compressed routing table scheme 902 both show example schemes to route packets through a portion of tiles of an 8×8 tile array. For example, as shown in FIG. 9, tiles 0-2, 8-10 and 16-18 may represent a portion of 2D mesh array of interconnected tiles (e.g., included in array 140 as shown in FIG. 1). In some examples, packets can be sourced or originate from tiles 0, 1 and 2. Examples are not limited to packets being sourced or originating from any particular portion of a 2D mesh array, tiles 0, 1 and 2 were used as example sources for simplicity.

In some examples, as shown in FIG. 9, routing table scheme 901 and compressed routing table scheme 902 depicts a contention-fee route for a packet sourced from tile 0, routed through tile 8 and destined for local compute elements at tile 16. Also depicted is a contention-fee route for a packet sourced from tile 1, routed through tile 9 and destined for local compute elements at tile 16. Also depicted is a contention-fee route for a packet sourced from tile 2, routed through tile 10 and destined for local compute elements at tile 19.

According to some examples, even though the same contention-free routes are used for routing table scheme 901 and compressed routing table scheme 902, routing tables used for each scheme are configured differently. For example, as shown in FIG. 9, encode values for 64 entries assigned to 64 separate source addresses are used in routing table scheme 901 and can utilize a 64-1 multiplexer to perform table look-up operations for a direction decoder to use to determine which destination port to route a packet. Also, as shown in FIG. 9, encoded values for 7 entries are used in compressed routing table scheme 902 and can thus use a significantly smaller 7-1 multiplexer to perform table look-up operations. For these examples, compressed routing table scheme 902 can use less memory capacity for storing the reduced number of routing table entries as compared to a 64 entry routing table used in routing table scheme 901.

As described in more detail below, a process flow can be implemented to compress source addresses based on non-overlapping paths for packets routed from a source to a destination. Compressed routing table scheme 902 shows an example of how tile 0 and tile 2 can be grouped or compressed into a same source address (Src Addr) of 0 since their respective paths to respective destination tiles do not overlap. Tile 1 maintains its Src Addr of 1 since its path overlaps with tile 0's path and thus cannot be grouped with tile 0. As shown in FIG. 9 for routing table scheme 901, routing tables at tiles 2, 10 and 18 include encoded values for entries assigned to addr=2 and these encoded values at addr=2 can be used to route a packet sourced from tile 2 to destination tile 18. Meanwhile, as shown in FIG. 9 for compressed routing table scheme 920, routing tables at tiles 2, 10 and 18 include encoded values for entries assigned to addr=0 and these encoded values at addr=0 can be used to route a packet sourced from tile 2 to destination tile 18.

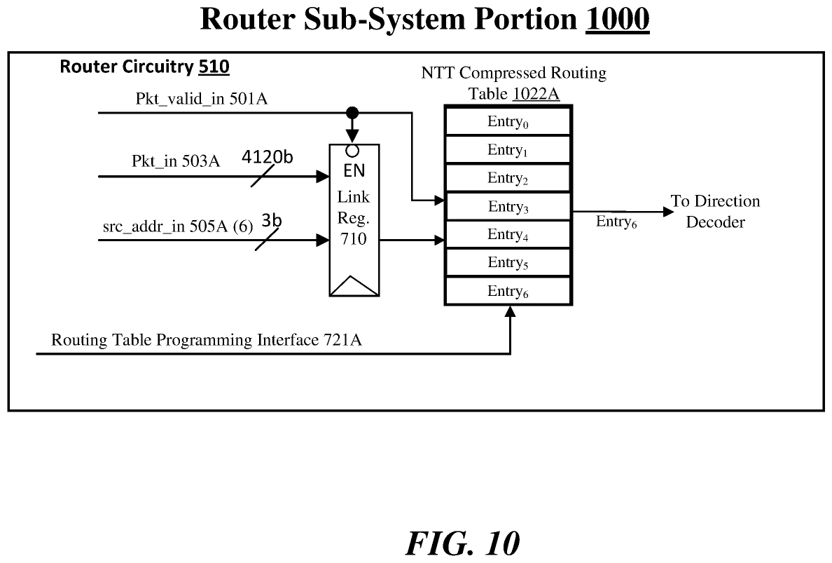

FIG. 10 illustrates an example router sub-system portion 1000. According to some examples, similar to router sub-system portion 800, router sub-system portion 1000 can represent any top channel router circuitry of router circuitry 510-1-4 of router sub-system 700 shown in FIG. 7 and described above. For these examples, as shown in FIG. 10, NTT compressed routing table 1022A includes a compressed routing table having entries 0-6. Respective entries 0-6 can be assigned to a grouped or compressed source address and based on a grouped or compressed source address indicated in src_addr-in 505A as (6) a table look-up operation can be performed to fetch an encoded value from the entry of NTT compressed routing table 1022A assigned to a source address for grouping of source tiles that do not have overlapping paths. The encoded value can then be provided to a direction decoder to determine what destination port to send a packet received via Pkt-in 503A signal that has a corresponding Pkt-valid_in 501A signal.

Although not shown in FIG. 10, a table look-up operation for a 7 entry NTT compressed routing table 1022A can require a reduced amount circuitry to a 7-1 multiplexer compared to 64-1 multiplexer that would be needed for an uncompressed 64 entry routing table. As described more below, an example process can be implemented to determine how to group or compress source addresses to use a compressed routing table like NTT compressed routing table 1022A.

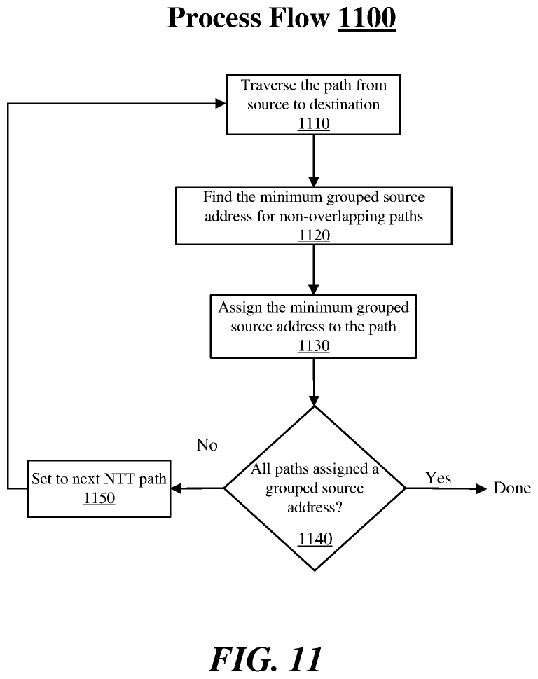

FIG. 11 illustrates an example process flow 1100. According to some examples, process flow 1100 can be implemented to determine what source addresses are to be grouped to facilitate routing of packets through a 2D mesh interconnect-based architecture such as shown in FIG. 1 and that can include interconnected tiles according to connection scheme 200 shown in FIG. 2. Also, an NTT routing schedule such as NTT routing schedule 300 shown in FIG. 3 can be utilized to encode compressed NTT routing tables that provide contention-fee routing paths for routing circuitry (e.g., router circuitry 510) to use for routing packets from a source tile to a destination tile of an array (e.g., array 140). Also, although not shown in FIG. 3, an iNTT routing schedule similar to NTT routing schedule 300 can also be used. Examples are not limited to a 64 tile array, the connection scheme shown in FIG. 2 or to iNTT/NTT routing schedules that can be arranged for NTT operations/computations associated with a 16K polynomial ring size. Tile arrays of larger or smaller numbers of tiles are contemplated for use in process flow 1100 as are iNTT/NTT operations/computations associated with larger or smaller polynomial ring sizes.

In some examples, at 1110, a first path is traversed from a source tile to a destination tile. For these examples, the grouping or compressing of source addresses can be based on NTT routing schedule 300 and the first path could be the path used to route packets from source tile 0 to destination tile 1. Examples are not limited to starting at tile 0 as the first tile for a path traverse.

According to some examples, at 1120, the minimum grouped source address for non-overlapping paths is found. For these examples, since this is the first path being checked the minimum grouped source address can be assigned to a source address of 0. In some examples, the assigned grouped source address can be referred to as a compressed source address. For subsequent paths, if an overlap is found with any source tile paths assigned to a grouped source address, the minimum assigned grouped source address is incremented. For example, paths starting at tiles 0, 1 and 2 do not have overlapping paths and can be assigned to grouped or compressed source address 0. However, tile 3's path has an overlap with tile 1's path (e.g., same destination tile 32) and thus the minimum assigned grouped source address is incremented to a source address of 1 and the path for tile 3 is assigned to grouped source address 1. Examples are not limited to starting at 0 and subsequently incrementing assigned grouped sources addresses. In other examples, assigned grouped address could start at a non-zero number (e.g., 6) and be decremented toward 0.

According to some examples, at 1140, each tile's path is checked and assigned to a minimum grouped source address until all paths have been assigned a grouped source address. For these examples, if all have been checked and assigned process flow 1100 is done. If not, process flow 1100 moves to 1150.

In some examples, at 1150, the next NTT path is set for traversal and process flow 1100 returns to 1110. For example, if the next NTT path is for source tile 1 to destination tile 32, then that is the next path to be set for traversal.

Unsorted and sorted examples of grouped or compressed source addresses for paths sourced from all 64 tiles are provided below for use to program both top and bottom channel NTT compressed routing tables. In some examples, process flow 1100 can be separately implemented to assign top channel (e.g., top channel 750A) iNTT or NTT grouped or compressed source addresses and to assign bottom channel (e.g., bottom channel 750B) iNTT or NTT grouped or compressed source addresses. As mentioned above for FIG. 7, top and bottom channels can be designed to accommodate two output lanes or channels from each tile. For these examples, iNTT or NTT compressed routing tables can be programmed (e.g., through routing table programming interface 721A or 721B) to include entries assigned to iNTT or NTT grouped or compressed source addresses. The programming of routing tables, for example, can occur at initiation of an FHE workload.

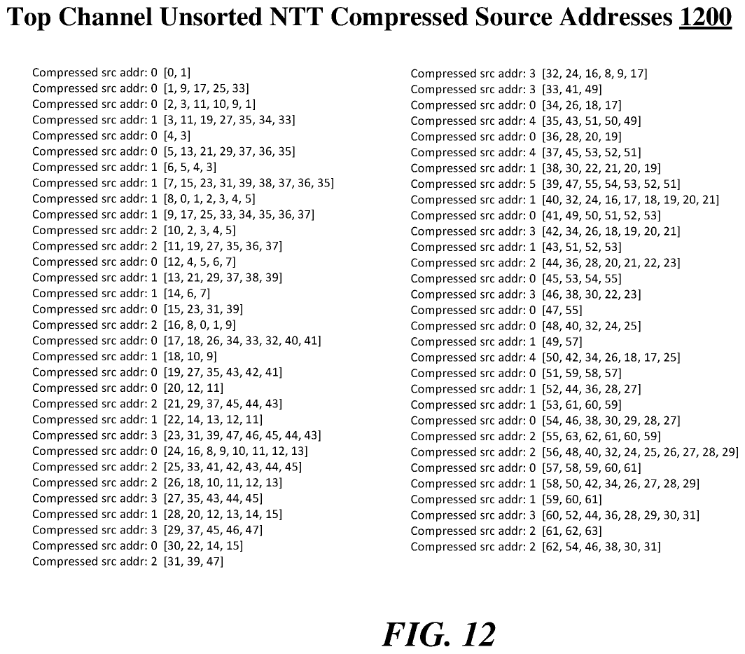

FIG. 12 illustrates top channel unsorted NTT compressed source addresses 1200. In some examples, the grouped or compressed source addresses shown in FIG. 12 provide an unsorted example of how contention-free paths through an 8×8 array tiles such as shown in FIG. 2 for tile array 140 and based on NTT routing schedule 300 shown in FIG. 3 can be assigned to grouped or compressed source addresses for as mentioned above for process flow 1100. The compressed source addresses included in top channel unsorted NTT compressed source addresses 1200 to be used to program entries in NTT compressed routing tables maintained in and used by top channel routing circuitry of a tile. For these examples, a total of 6 compressed source addresses 0-5 are assigned. A compressed source address for tile 63 is not included in top channel unsorted NTT compressed source addresses 1200 because the interconnect between tiles 63 and 62 in this path is only used at a bottom channel of router circuitry maintained at tile 63, while the top channel delivers the packet from tile 63 to itself (e.g., local destination port). The paths shown in FIG. 12 for top channel unsorted NTT compressed source addresses 1200 can represent one of multiple options for contention-free paths through tile array 140 for a top channel.

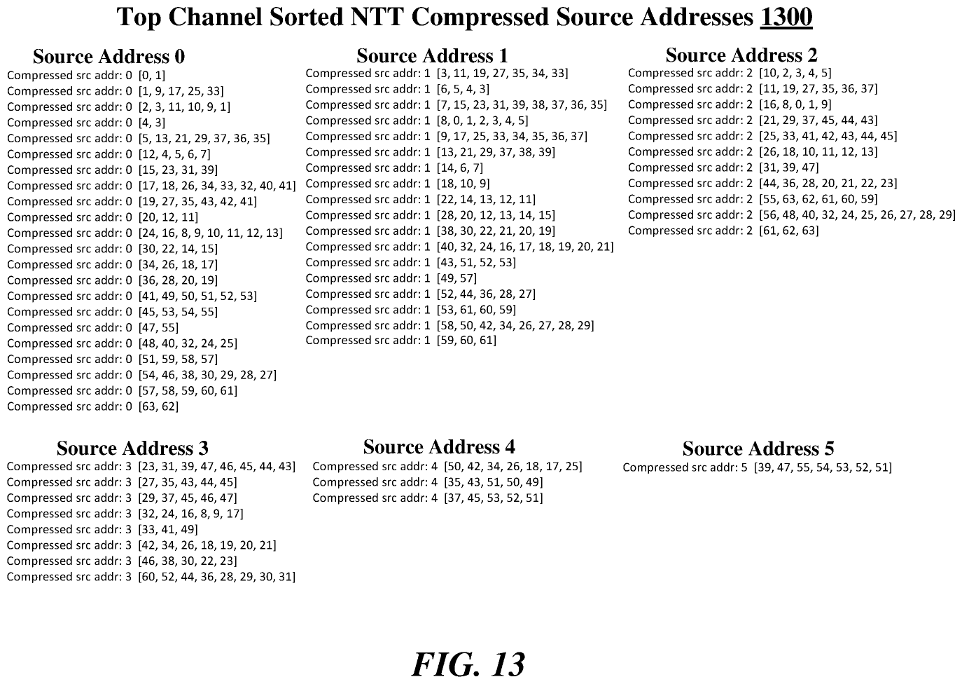

FIG. 13 illustrates example top channel sorted NTT compressed source addresses 1300. According to some examples, as shown in FIG. 13, paths assigned to compressed source addresses are sorted to depict how each path assigned to a given compressed source address do not have overlapping destination tiles. Top channel sorted NTT compressed source addresses 1300 also show how assigning a path to a minimum grouped source address causes source address 0 to have the highest number of paths and source address 5 to have the lowest number.

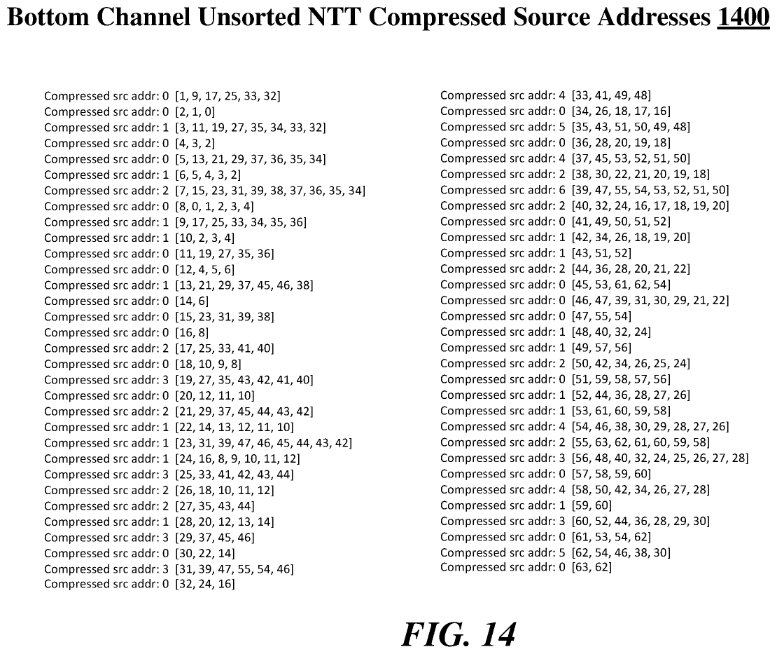

FIG. 14 illustrates bottom channel unsorted NTT compressed source addresses 1400. According to some examples, the grouped or compressed source addresses shown in FIG. 14 provide an unsorted example of how contention-free paths through an 8×8 array tiles such as shown in FIG. 2 for tile array 140 and based on NTT routing schedule 300 shown in FIG. 3 can be assigned to grouped or compressed source addresses for as mentioned above for process flow 1100. The compressed source addresses included in bottom channel unsorted NTT compressed source addresses 1400 to be used to program entries in NTT compressed routing tables maintained in and used by bottom channel routing circuitry of a tile. For these examples, a total of 7 compressed source addresses 0-6 are assigned. A compressed source address for tile 0 is not included in bottom channel unsorted NTT compressed source addresses 1400 because the interconnect between tiles 0 and 1 in this path is only used at a top channel of router circuitry maintained at tile 0, while the bottom channel delivers the packet from tile 0 to itself (e.g., local destination port). The paths shown in FIG. 14 for bottom channel unsorted NTT compressed source addresses 1400 can represent one of multiple options for contention-free paths through tile array 140 for a bottom channel.

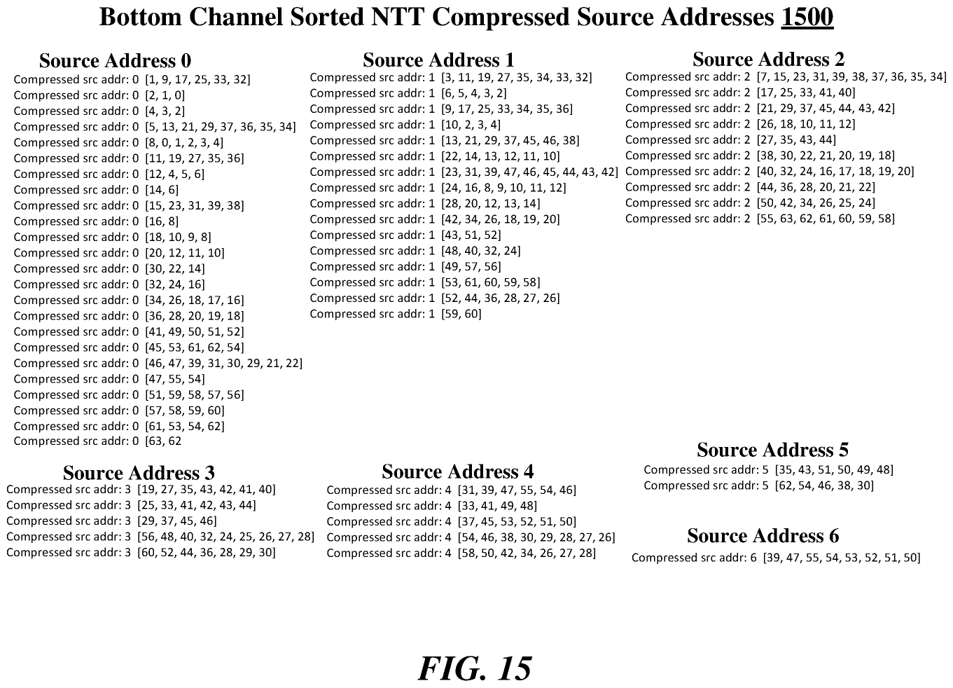

FIG. 15 illustrates example bottom channel sorted NTT compressed source addresses 1500. According to some examples, as shown in FIG. 15, paths assigned to compressed source addresses are sorted to depict how each path assigned to a given compressed source address do not have overlapping destination tiles. Bottom channel sorted NTT compressed source addresses 1500 also show how assigning a path to a minimum grouped source address causes source address 0 to have the highest number of paths and source address 6 to have the lowest number.

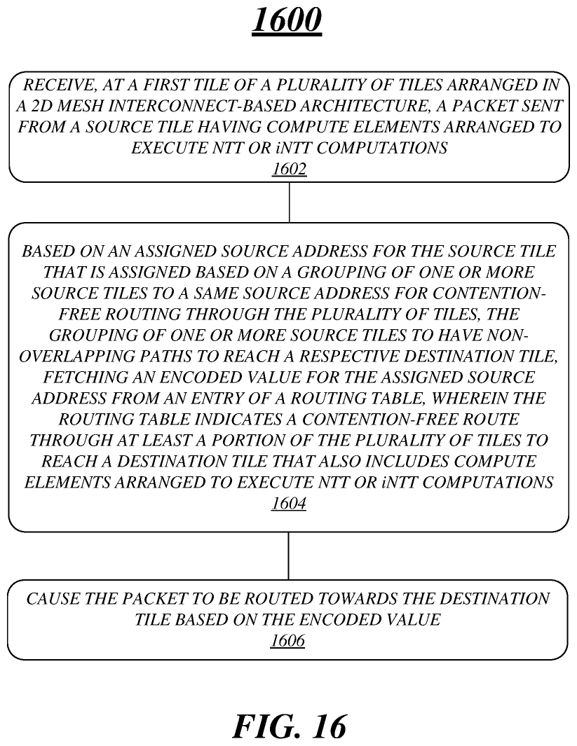

FIG. 16 illustrates an example logic flow 1600. Logic flow 1600 is representative of the operations implemented by logic and/or features of a router circuitry resident on or closely coupled with a tile. For example, logic and/or features of router circuitry 510-1, 510-2, 510-3 or 510-4 as shown in FIGS. 5 and 7 and described above for router sub-system portion 1000 as shown in FIG. 10. The router circuitry can be configured to implement a compressed routing table scheme such as described above for compressed routing table scheme 902 shown in FIG. 9 using compressed source addresses assigned to paths as described in process flow 1100. The assigned compressed source addresses can be used to program entry values in compressed routing tables maintained and/or used by the router circuitry. Top and bottom channel router circuitry can be included in a tile such as tile 140-10 of tile array 140 that includes a plurality of compute elements such as compute elements 410-1 to 410-128 as shown in FIGS. 4 and 5.

In some examples, as shown in FIG. 16, logic flow 1600 at block 1602 can receive, at a first tile of a plurality of tiles arranged in a 2-D mesh interconnect-based architecture, a packet sent from a source tile having compute elements arranged to execute NTT or iNTT computations. For example, route circuitry 510-1 of tile 140-10 receives a packet sent from a source tile included in tile array 140 in association with NTT computations, the packet received via an Pkt_in 503A signal of top channel 750A.

According to some examples, logic flow 1600 at block 1604 can based an assigned source address for the source tile that is assigned based on a grouping of one or more source tiles to a same source address for contention-free routing through the plurality of tiles, the grouping of one or more source tiles to have non-overlapping paths to reach a respective destination tile, fetching an encoded value for the assigned source address from an entry of a routing table, wherein the routing table indicates a contention-free route through at least a portion of the plurality of tiles to reach a destination tile that also includes compute elements arranged to execute NTT or iNTT computations. For example, router circuitry 510 uses the assigned source address for the source tile to fetch an encoded value for the assigned source address that is maintained in an entry of a NTT compressed routing table 1022A. The encode value to indicate which output port of top channel 750A to route the packet received from the source tile.

In some examples, logic flow 1600 at block 1606 can cause the packet to be routed towards the destination tile based on the encoded value. For example, a direction can use the fetched encode value (e.g., encoded according to example direction table 600) to determine whether the packet is routed towards one of a west, east, north, south or local output port to reach its destination. In some examples, the tile including the router circuitry 510 is also the destination tile. For these examples, the packet is routed towards a local output port that sends the packet to compute elements 410-1 to 410-128.

The logic flow shown in FIG. 16 can be representative of example methodologies for performing novel aspects described in this disclosure. While, for purposes of simplicity of explanation, the one or more methodologies shown herein are shown and described as a series of acts, those skilled in the art will understand and appreciate that the methodologies are not limited by the order of acts. Some acts can, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology can be required for a novel implementation.

A logic flow can be implemented in software, firmware, and/or hardware. In software and firmware embodiments, a software or logic flow can be implemented by computer executable instructions stored on at least one non-transitory computer readable medium or machine readable medium, such as an optical, magnetic or semiconductor storage. The embodiments are not limited in this context.

Detailed below are descriptions of example computer architectures. Other system designs and configurations known in the arts for laptop, desktop, and handheld personal computers (PC) s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

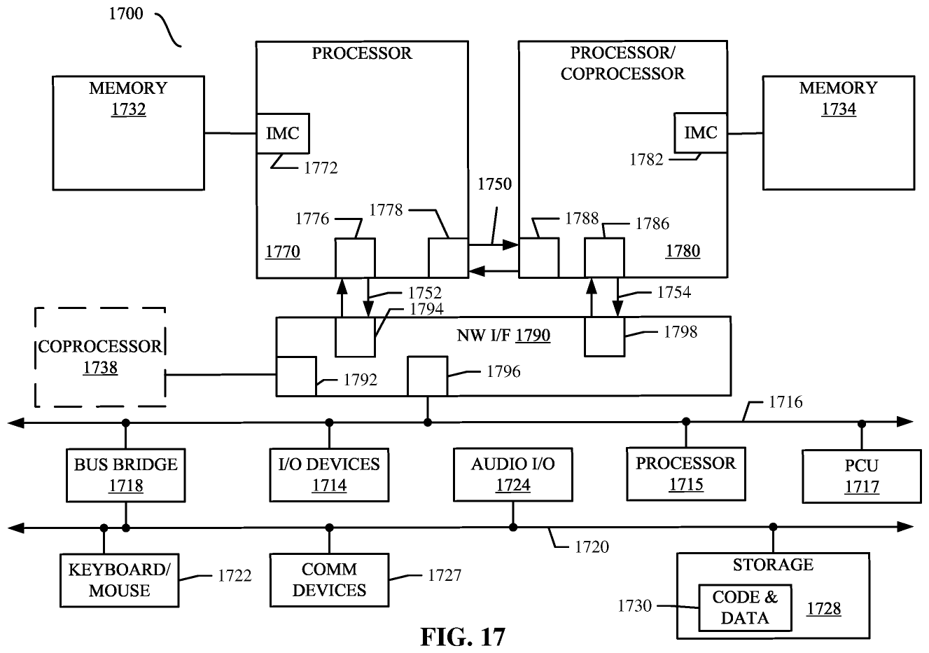

FIG. 17 illustrates an example computing system. Multiprocessor system 1700 is an interfaced system and includes a plurality of processors or cores including a first processor 1770 and a second processor 1780 coupled via an interface 1750 such as a point-to-point (P-P) interconnect, a fabric, and/or bus. In some examples, the first processor 1770 and the second processor 1780 are homogeneous. In some examples, first processor 1770 and the second processor 1780 are heterogenous. Though the example system 1700 is shown to have two processors, the system may have three or more processors, or may be a single processor system. In some examples, the computing system is a system on a chip (SoC).

Processors 1770 and 1780 are shown including integrated memory controller (IMC) circuitry 1772 and 1782, respectively. Processor 1770 also includes interface circuits 1776 and 1778; similarly, second processor 1780 includes interface circuits 1786 and 1788. Processors 1770, 1780 may exchange information via the interface 1750 using interface circuits 1778, 1788. IMCs 1772 and 1782 couple the processors 1770, 1780 to respective memories, namely a memory 1732 and a memory 1734, which may be portions of main memory locally attached to the respective processors.

Processors 1770, 1780 may each exchange information with a network interface (NW I/F) 1790 via individual interfaces 1752, 1754 using interface circuits 1776, 1794, 1786, 1798. The network interface 1790 (e.g., one or more of an interconnect, bus, and/or fabric, and in some examples is a chipset) may optionally exchange information with a co-processor 1738 via an interface circuit 1792. In some examples, the co-processor 1738 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 1770, 1780 or outside of both processors, yet connected with the processors via an interface such as P-P interconnect, such that either or both processors' local cache information may be stored in the shared cache if a processor is placed into a low power mode.

Network interface 1790 may be coupled to a first interface 1716 via interface circuit 1796. In some examples, first interface 1716 may be an interface such as a Peripheral Component Interconnect (PCI) interconnect, a PCI Express interconnect or another I/O interconnect. In some examples, first interface 1716 is coupled to a power control unit (PCU) 1712, which may include circuitry, software, and/or firmware to perform power management operations with regard to the processors 1770, 1780 and/or co-processor 1738. PCU 1712 provides control information to a voltage regulator (not shown) to cause the voltage regulator to generate the appropriate regulated voltage. PCU 1712 also provides control information to control the operating voltage generated. In various examples, PCU 1712 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 1712 is illustrated as being present as logic separate from the processor 1770 and/or processor 1780. In other cases, PCU 1712 may execute on a given one or more of cores (not shown) of processor 1770 or 1780. In some cases, PCU 1712 may be implemented as a microcontroller (dedicated or general-purpose) or other control logic configured to execute its own dedicated power management code, sometimes referred to as P-code. In yet other examples, power management operations to be performed by PCU 1712 may be implemented externally to a processor, such as by way of a separate power management integrated circuit (PMIC) or another component external to the processor. In yet other examples, power management operations to be performed by PCU 1712 may be implemented within BIOS or other system software.

Various I/O devices 1714 may be coupled to first interface 1716, along with a bus bridge 1718 which couples first interface 1716 to a second interface 1720. In some examples, one or more additional processor(s) 1715, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 1716. In some examples, second interface 1720 may be a low pin count (LPC) interface. Various devices may be coupled to second interface 1720 including, for example, a keyboard and/or mouse 1722, communication devices 1727 and storage circuitry 1728. Storage circuitry 1728 may be one or more non-transitory machine-readable storage media as described below, such as a disk drive or other mass storage device which may include instructions/code and data 1730 and may implement the storage ‘ISAB03 in some examples. Further, an audio I/O 1724 may be coupled to second interface 1720. Note that other architectures than the point-to-point architecture described above are possible. For example, instead of the point-to-point architecture, a system such as multiprocessor system 1700 may implement a multi-drop interface or other such architecture.

Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

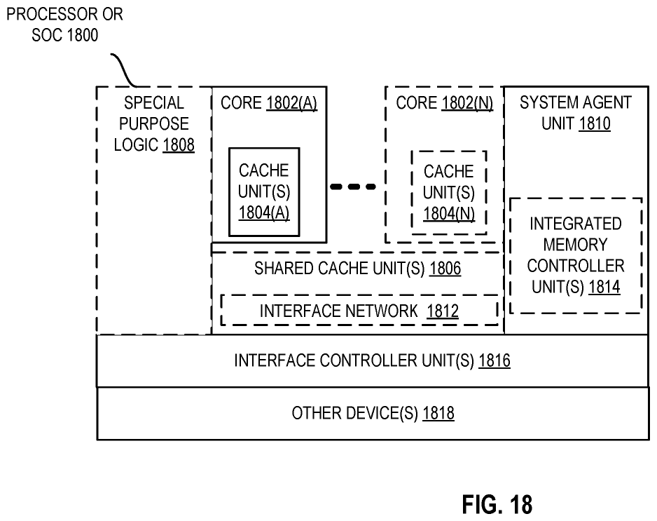

FIG. 18 illustrates a block diagram of an example processor and/or SoC 1800 that may have one or more cores and an integrated memory controller. The solid lined boxes illustrate a processor 1800 with a single core 1802 (A), system agent unit circuitry 1810, and a set of one or more interface controller unit(s) circuitry 1816, while the optional addition of the dashed lined boxes illustrates an alternative processor 1800 with multiple cores 1802 (A)-(N), a set of one or more integrated memory controller unit(s) circuitry 1814 in the system agent unit circuitry 1810, and special purpose logic 1808, as well as a set of one or more interface controller units circuitry 1816. Note that the processor 1800 may be one of the processors 1770 or 1780, or co-processor 1738 or 1715 of FIG. 17.

Thus, different implementations of the processor 1800 may include: 1) a CPU with the special purpose logic 1808 being integrated graphics and/or scientific (throughput) logic (which may include one or more cores, not shown), and the cores 1802 (A)-(N) being one or more general purpose cores (e.g., general purpose in-order cores, general purpose out-of-order cores, or a combination of the two); 2) a coprocessor with the cores 1802 (A)-(N) being a large number of special purpose cores intended primarily for graphics and/or scientific (throughput); and 3) a coprocessor with the cores 1802 (A)-(N) being a large number of general purpose in-order cores. Thus, the processor 1800 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 1800 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 1804 (A)-(N) within the cores 1802 (A)-(N), a set of one or more shared cache unit(s) circuitry 1806, and external memory (not shown) coupled to the set of integrated memory controller unit(s) circuitry 1814. The set of one or more shared cache unit(s) circuitry 1806 may include one or more mid-level caches, such as level 2 (L2), level 3 (L3), level 4 (L4), or other levels of cache, such as a last level cache (LLC), and/or combinations thereof. While in some examples interface network circuitry 1812 (e.g., a ring interconnect) interfaces the special purpose logic 1808 (e.g., integrated graphics logic), the set of shared cache unit(s) circuitry 1806, and the system agent unit circuitry 1810, alternative examples use any number of well-known techniques for interfacing such units. In some examples, coherency is maintained between one or more of the shared cache unit(s) circuitry 1806 and cores 1802 (A)-(N). In some examples, interface controller units circuitry 1816 couple the cores 1802 to one or more other devices 1818 such as one or more I/O devices, storage, one or more communication devices (e.g., wireless networking, wired networking, etc.), etc.

In some examples, one or more of the cores 1802 (A)-(N) are capable of multi-threading. The system agent unit circuitry 1810 includes those components coordinating and operating cores 1802 (A)-(N). The system agent unit circuitry 1810 may include, for example, power control unit (PCU) circuitry and/or display unit circuitry (not shown). The PCU may be or may include logic and components needed for regulating the power state of the cores 1802 (A)-(N) and/or the special purpose logic 1808 (e.g., integrated graphics logic). The display unit circuitry is for driving one or more externally connected displays.

The cores 1802 (A)-(N) may be homogenous in terms of instruction set architecture (ISA). Alternatively, the cores 1802 (A)-(N) may be heterogeneous in terms of ISA; that is, a subset of the cores 1802 (A)-(N) may be capable of executing an ISA, while other cores may be capable of executing only a subset of that ISA or another ISA.

The following examples pertain to additional examples of technologies disclosed herein.

Example 1. An example apparatus can include at least one compute element arranged to execute NTT or iNTT computations, the at least one compute element at a first tile of a plurality of tiles arranged in a 2D mesh interconnect-based architecture. The example apparatus can also include router circuitry maintained at the first tile. The router circuitry can receive a packet sent from a source tile from among the plurality of tiles. The source tile can include compute elements arranged to execute NTT or iNTT computations. The router circuitry can also fetch an encoded value that can be based on an assigned source address for the source tile that is assigned based on a grouping of one or more source tiles to a same source address for contention-free routing through the plurality of tiles, the grouping of one or more source tiles to have non-overlapping paths to reach a respective destination tile. The value can be fetched value for the assigned source address from in an entry of a routing table. The routing table can indicate a contention-free route through at least a portion of the plurality of tiles to reach a destination tile that also includes compute elements arranged to execute NTT or iNTT computations. The router circuitry can also cause the packet to be routed towards the destination tile based on the encoded value.

Example 2. The apparatus of example 1, the routing table can be capable of being reconfigured responsive to a change to the NTT or iNTT computations to be executed by compute elements at tiles included in the plurality of tiles such that contention-free routes through the plurality of tiles correspondingly change.

Example 3. The apparatus of example 1, the compute elements of the source tile can be butterfly circuits to generate 2 outputs based on 2 inputs to execute NTT or iNTT computations. For this example, the received packet can include data generated by butterfly circuits at the source tile that is from 1 of the 2 outputs.

Example 4. The apparatus of example 3, the router circuitry can include a top channel router circuitry configured to route a first output from among the 2 outputs and a bottom channel router circuitry configured to route a second output from among the 2 outputs.

Example 5. The apparatus of example 1, the NTT or iNTT computations can be associated with a 16,384 polynomial ring size to be used for execution of a fully homomorphic encryption workload, wherein the plurality of tiles includes 64 tiles, each tile including 128 compute elements.

Example 6. The apparatus of example 5, the grouping of one or more source tiles to a same source address for contention-free routing through the plurality of tiles can cause a reduction in entries of the routing table from 64 entries for the 64 tiles to 7 or less entries for the 64 tiles.

Example 7. The apparatus of example 1, the router circuitry can include an east, a west, a north, a south or a local output port, wherein the encoded value indicates which output port to route the packet to cause the packet to be routed towards the destination tile.

Example 8. An example method can include receiving, at a first tile of a plurality of tiles arranged in a 2D mesh interconnect-based architecture, a packet sent from a source tile having compute elements arranged to execute NTT or iNTT computations. The example method can also include fetching an encoded value that is based on an assigned source address for the source tile that is assigned based on a grouping of one or more source tiles to a same source address for contention-free routing through the plurality of tiles, the grouping of one or more source tiles to have non-overlapping paths to reach a respective destination tile. The encoded value for the assigned source address can be fetched from in an entry of a routing table. The routing table can indicate a contention-free route through at least a portion of the plurality of tiles to reach a destination tile that also includes compute elements arranged to execute NTT or iNTT computations. The method can also include causing the packet to be routed towards the destination tile based on the encoded value.

Example 9. The method of example 8, the routing table can be capable of being reconfigured responsive to a change to the NTT or iNTT computations to be executed by compute elements at tiles included in the plurality of tiles such that contention-free routes through the plurality of tiles correspondingly change.

Example 10. The method of example 8, the compute elements of the source tile can be butterfly circuits to generate 2 outputs based on 2 inputs to execute NTT or iNTT computations. The received packet can include data generated by butterfly circuits at the source tile that is from 1 of the 2 outputs.

Example 11. The method of example 8, the NTT or iNTT computations can be associated with a 16,384 polynomial ring size to be used for execution of a fully homomorphic encryption workload, wherein the plurality of tiles includes 64 tiles, each tile including 128 compute elements.

Example 12. The method of example 11, the grouping of one or more source tiles to a same source address for contention-free routing through the plurality of tiles can cause a reduction in entries of the routing table from 64 entries for the 64 tiles to 7 or less entries for the 64 tiles.

Example 13. The method of example 8, the packet can be received by router circuitry of the first tile.

Example 14. The method of example 13, the encoded value can indicate one of an east, a west, a north, a south or a local output port of the router circuitry to be used to route the packet towards the destination tile.

Example 15. An example at least one machine readable medium can include a plurality of instructions that in response to being executed by a system can cause the system to carry out a method according to any one of examples 8 to 14.

Example 16. An example apparatus can include means for performing the methods of any one of examples 8 to 14.

Example 17. An example system can include a source tile from among a plurality of tiles arranged in a 2D mesh interconnect-based architecture. The source tile can include compute elements arranged to execute NTT or iNTT computations. The system can also include a destination tile from among the plurality of tiles. The destination tile can also include compute elements arranged to execute NTT or iNTT computations. The system can also include an intermediate tile from among the plurality of tiles. The intermediate tile can also include compute elements arranged to execute NTT or iNTT computations. The intermediate tile can include router circuitry to receive a packet sent from the source tile. The router circuitry can also fetch an encoded value that can be based on an assigned source address for the source tile that is assigned based on a grouping of one or more source tiles to a same source address for contention-free routing through the plurality of tiles, the grouping of one or more source tiles to have non-overlapping paths to reach a respective destination tile. The encoded value for the assigned source address can be fetched from an entry of a routing table. The routing table can indicate a contention-free route through at least a portion of the plurality of tiles to reach the destination tile. The router circuitry can also cause the packet to be routed towards the destination tile based on the encoded value.

Example 18. The system of example 17, the routing table can be capable of being reconfigured responsive to a change to the NTT or iNTT computations to be executed by compute elements at tiles included in the plurality of tiles such that contention-free routes through the plurality of tiles correspondingly change.

Example 19. The system of example 17, the compute elements of the source tile can be butterfly circuits to generate 2 outputs based on 2 inputs to execute NTT or iNTT computations, wherein the received packet includes data generated by butterfly circuits at the source tile that is from 1 of the 2 outputs.

Example 20. The system of example 17, the router circuitry can include a top channel router circuitry configured to route a first output from among the 2 outputs and a bottom channel router circuitry configured to route a second output from among the 2 outputs.

Example 21. The system of example 17, the NTT or iNTT computations can be associated with a 16,384 polynomial ring size to be used for execution of a fully homomorphic encryption workload, wherein the plurality of tiles include 64 tiles, each tile including 128 compute elements.

Example 22. The system of example 21, the grouping of one or more source tiles to a same source address for contention-free routing through the plurality of tiles can cause a reduction in entries of the routing table from 64 entries for the 64 tiles to 7 or less entries for the 64 tiles.

Example 23. The system of example 17, the router circuitry can include an east, a west, a north, a south or a local output port, wherein the encoded value indicates which output port to route the packet to cause the packet to be routed towards the destination tile.

It is emphasized that the Abstract of the Disclosure is provided to comply with 37 C.F.R. Section 1.72 (b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

While various examples described herein could use the System-on-a-Chip or System-on-Chip (“SoC”) to describe a device or system having a processor and associated circuitry (e.g., Input/Output (“I/O”) circuitry, power delivery circuitry, memory circuitry, etc.) integrated monolithically into a single integrated circuit (“IC”) die, or chip, the present disclosure is not limited in that respect. For example, in various examples of the present disclosure, a device or system could have one or more processors (e.g., one or more processor cores) and associated circuitry (e.g., Input/Output (“I/O”) circuitry, power delivery circuitry, etc.) arranged in a disaggregated collection of discrete dies, tiles and/or chiplets (e.g., one or more discrete processor core die arranged adjacent to one or more other die such as memory die, I/O die, etc.). In such disaggregated devices and systems the various dies, tiles and/or chiplets could be physically and electrically coupled together by a package structure including, for example, various packaging substrates, interposers, interconnect bridges and the like. Also, these disaggregated devices can be referred to as a system-on-a-package (SoP).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus comprising:
at least one compute element arranged to execute number-theoretic-transform (NTT) or inverse-NTT (iNTT) computations, the at least one compute element at a first tile of a plurality of tiles arranged in a 2-dimensional mesh interconnect-based architecture; and
router circuitry maintained at the first tile, the router circuitry to:
receive a packet sent from a source tile from among the plurality of tiles, wherein the source tile includes compute elements arranged to execute NTT or iNTT computations;
based on an assigned source address for the source tile that is assigned based on a grouping of one or more source tiles to a same source address for contention-free routing through the plurality of tiles, the grouping of one or more source tiles to have non-overlapping paths to reach a respective destination tile, fetch an encoded value for the assigned source address from in an entry of a routing table, wherein the routing table indicates a contention-free route through at least a portion of the plurality of tiles to reach a destination tile that also includes compute elements arranged to execute NTT or iNTT computations; and
cause the packet to be routed towards the destination tile based on the encoded value.

2. The apparatus of claim 1, wherein the routing table is capable of being reconfigured responsive to a change to the NTT or iNTT computations to be executed by compute elements at tiles included in the plurality of tiles such that contention-free routes through the plurality of tiles correspondingly change.

3. The apparatus of claim 1, wherein the compute elements of the source tile comprise butterfly circuits to generate 2 outputs based on 2 inputs to execute NTT or iNTT computations, wherein the received packet includes data generated by butterfly circuits at the source tile that is from 1 of the 2 outputs.

4. The apparatus of claim 3, wherein the router circuitry includes a top channel router circuitry configured to route a first output from among the 2 outputs and a bottom channel router circuitry configured to route a second output from among the 2 outputs.

5. The apparatus of claim 1, wherein the NTT or iNTT computations are associated with a 16,384 polynomial ring size to be used for execution of a fully homomorphic encryption workload, wherein the plurality of tiles includes 64 tiles, each tile including 128 compute elements.

6. The apparatus of claim 5, wherein the grouping of one or more source tiles to a same source address for contention-free routing through the plurality of tiles causes a reduction in entries of the routing table from 64 entries for the 64 tiles to 7 or less entries for the 64 tiles.

7. The apparatus of claim 1, wherein the router circuitry includes an east, a west, a north, a south or a local output port, wherein the encoded value indicates which output port to route the packet to cause the packet to be routed towards the destination tile.

8. A method comprising:
receiving, at a first tile of a plurality of tiles arranged in a 2-dimensional mesh interconnect-based architecture, a packet sent from a source tile having compute elements arranged to execute number-theoretic-transform (NTT) or inverse-NTT (iNTT) computations;
based on an assigned source address for the source tile that is assigned based on a grouping of one or more source tiles to a same source address for contention-free routing through the plurality of tiles, the grouping of one or more source tiles to have non-overlapping paths to reach a respective destination tile, fetching an encoded value for the assigned source address from in an entry of a routing table, wherein the routing table indicates a contention-free route through at least a portion of the plurality of tiles to reach a destination tile that also includes compute elements arranged to execute NTT or iNTT computations; and
causing the packet to be routed towards the destination tile based on the encoded value.

9. The method of claim 8, wherein the routing table is capable of being reconfigured responsive to a change to the NTT or iNTT computations to be executed by compute elements at tiles included in the plurality of tiles such that contention-free routes through the plurality of tiles correspondingly change.

10. The method of claim 8, wherein the compute elements of the source tile comprise butterfly circuits to generate 2 outputs based on 2 inputs to execute NTT or iNTT computations, wherein the received packet includes data generated by butterfly circuits at the source tile that is from 1 of the 2 outputs.

11. The method of claim 8, wherein the NTT or iNTT computations are associated with a 16,384 polynomial ring size to be used for execution of a fully homomorphic encryption workload, wherein the plurality of tiles includes 64 tiles, each tile including 128 compute elements.

12. The method of claim 11, wherein the grouping of one or more source tiles to a same source address for contention-free routing through the plurality of tiles causes a reduction in entries of the routing table from 64 entries for the 64 tiles to 7 or less entries for the 64 tiles.

13. The method of claim 8, wherein the packet is received by router circuitry of the first tile.

14. The method of claim 13, wherein the encoded value indicates one of an east, a west, a north, a south or a local output port of the router circuitry to be used to route the packet towards the destination tile.

15. An system comprising:
a source tile from among a plurality of tiles arranged in a 2-dimensional mesh interconnect-based architecture, the source tile includes compute elements arranged to execute number-theoretic-transform (NTT) or inverse-NTT (iNTT) computations;
a destination tile from among the plurality of tiles, the destination tile to also include compute elements arranged to execute NTT or iNTT computations; and
an intermediate tile from among the plurality of tiles, the intermediate tile to also include compute elements arranged to execute NTT or iNTT computations, wherein the intermediate tile includes router circuitry to:
receive a packet sent from the source tile;
based on an assigned source address for the source tile that is assigned based on a grouping of one or more source tiles to a same source address for contention-free routing through the plurality of tiles, the grouping of one or more source tiles to have non-overlapping paths to reach a respective destination tile, fetch an encoded value for the assigned source address from an entry of a routing table, wherein the routing table indicates a contention-free route through at least a portion of the plurality of tiles to reach the destination tile; and
cause the packet to be routed towards the destination tile based on the encoded value.

16. The system of claim 15, wherein the compute elements of the source tile comprise butterfly circuits to generate 2 outputs based on 2 inputs to execute NTT or iNTT computations, wherein the received packet includes data generated by butterfly circuits at the source tile that is from 1 of the 2 outputs.

17. The system of claim 16, wherein the router circuitry includes a top channel router circuitry configured to route a first output from among the 2 outputs and a bottom channel router circuitry configured to route a second output from among the 2 outputs.

18. The system of claim 15, wherein the NTT or iNTT computations are associated with a 16,384 polynomial ring size to be used for execution of a fully homomorphic encryption workload, wherein the plurality of tiles include 64 tiles, each tile including 128 compute elements.

19. The system of claim 18, wherein the grouping of one or more source tiles to a same source address for contention-free routing through the plurality of tiles causes a reduction in entries of the routing table from 64 entries for the 64 tiles to 7 or less entries for the 64 tiles.

20. The system of claim 15, wherein the router circuitry includes an east, a west, a north, a south or a local output port, wherein the encoded value indicates which output port to route the packet to cause the packet to be routed towards the destination tile.
